(19) United States
(12) Patent Application Publication
(10) Pub. No.: US 2004/0067597 A1
(43) Pub. Date: Apr. 8, 2004

(54) High density reagent array preparation methods

(75) Inventors: Sammy S. Datwani, Menlo Park, CA (US); Sherri A. Biondi, Los Altos, CA (US); Ravi Vijanyendran, Mountain View, CA (US); Tex Horning, Sunnyvale, CA (US); Shodana Song, (US)

Correspondence Address: CALIPER TECHNOLOGIES CORP, 605 FAIRCHILD DRIVE, MOUNTAIN VIEW, CA, 94043, US

(73) Assignee: Caliper Technologies Corp., Mountain View, CA

(21) Appl. No.: 10/630,357

(22) Filed: Jul. 30, 2003

Related U.S. Application Data
(60) Provisional application No. 60/400,458, filed on Jul. 31, 2002.

(51) Int. Cl. G01N 1/10

(52) U.S. Cl. 436/180; 422/58

(57) ABSTRACT

This invention provides reagent array chips having, e.g., reagents spotted at a high density onto self-assembled monolayers (SAMs) for consistent and high recovery. The invention teaches, e.g., methods to make and use reagent array chips to screen for protease substrates. Identified substrates can, e.g., then be used to screen for modulators of the protease activity and to establish quantitative assays for the protease.

### FIELD OF THE INVENTION

The invention is in the field of high-density array chips and methods to prepare and use such chips. Embodiments of the present invention relate to reagent array chips having a self-assembled monolayer (SAM) reagent spotting surface that provides consistent spotting and recovery of the reagents. Embodiments of the invention also provide patterned SAM surfaces on reagent chips and methods of spotting high-density reagent arrays. Method in accordance with the present invention includes methods of applying alignment marks to facilitate efficient and accurate determination of reagent spot locations on a high-density array chip.

### BACKGROUND OF THE INVENTION

Libraries of chemical reagents and biological reagents in dense arrays are used to screen for desired bioactivity in bio-medical research. The number of reagents in a library is often quite large, making high-density sampling and efficient handling a priority for practical high throughput screening applications. To obtain comparable experimental results between analytical assays, reagents must be consistently recovered from libraries.

Historically, the pharmaceutical industry has collected or synthesized large numbers of organic chemicals for manual creation of libraries for screening. For example, in a search for new antibiotics chemicals were stored refrigerated in small flasks and then painstakingly removed and manually spotted onto lawns of bacteria.

With the advent of biotechnology and robotics, methods have been devised to prepare libraries of biomolecules containing hundreds of thousands, millions, or even billions of members. For example, libraries of nucleotide sequences, antibodies, viruses and synthetic peptides that represent much of the theoretical diversity for each type of biomolecule have been prepared.

Many modern reagent libraries are stored frozen as master libraries in containers such as 96-well microtiter dishes. Replicate library arrays are prepared from the master library to provide for research and screening on high-density array chips. Robotic fluid handling equipment is available to repeatedly prepare replicate arrays at high density from the master microtiter plates. With multiple replicate array chips available, the master library does not have to be thawed and aliquoted for every experiment.

One type of array chip is simply a glass slide with reagents spotted onto the surface in rows and columns. For example, reagents can be applied (spotted) by dipping a comb-like set of 1 mm diameter flat tipped pins into master library wells for transfer of reagents to array chips, by touching the wet pins to the glass surface. Using this technology, about 1 μL of each reagent can be spotted to positions spaced every 1 to 2 mm on the chip. The reagents arrays are allowed to dry before storage or use.

To recover the reagents from an array on a chip, the robot must locate each spot and accurately deliver about 5 μL of recovery buffer through a hollow bore sipper tube. After a moment's hesitation, for the reagent to dissolve in the buffer, the reagent is aspirated up into the sipper. The recovered reagent can then be delivered to chemical, immunological or bioassay reaction mixtures to screen for desired reaction results. The step of reagent recovery has many difficult aspects including the difficulty of locating reagent spots, preventing mixing of reagents in the dense array, obtaining high recovery of reagents, and obtaining consistent recovery of reagents. These difficulties have placed a limit on the usefulness of some arrays and on the spotting density of array chips.

Alignment of the sippers with reagent spots can be difficult in a dense array. The dried reagent spots are often translucent or clear, so alignment marks, with known locations relative to the array, are necessary references to put the sippers in register with the reagent spots. Reagent array chips are commercially available with alignment marks already printed on the surface. To use the chips with preprinted alignment marks, an instrument operator manually aligns the spotting pins with the alignment mark before spotting can begin. The operator performs a second alignment of the sippers before the reagents can be recovered.

On a dense array chip, application of recovery buffer can lead to cross contamination between spot locations. The glass chip surface (such as, e.g., quartz, borosilicate, or Pyrex) may not present a perfectly homogenous interface when reagents are spotted. As the reagents dry, they can contract off center or form jagged edges. When recovery buffer is applied to the spots, it can spread outside the intended spot array location. Spreading buffers can come in contact with recovery buffers from adjacent spot locations. Poor alignment of sippers during recovery operations can compound buffer spreading. Cross-contamination from wandering recovery buffers places a practical limit on array chip reagent spot density.

Broad and irregular spreading of spotted reagents and recovery buffers can reduce recovery of reagents from an array chip. Broad spreading exposes reagents to a larger chip surface area where nonspecific adsorption of reagents can reduce the availability of some reagent elements. Irregular and broad spreading provide less favorable mixing characteristics for the recovery buffer and less efficient dissolution.

Consistent reagent recovery can be a problem with current chip technologies. Nonuniformity of chip surfaces can cause irregular and off-center reagent spots, as described above. Irregularities at the chip surface can also contribute to variable non-specific adsorption of reagents at the chip surface. These drying and adsorption irregularities can cause inconsistent recovery of reagents that adds a significant variable to experimental design and interpretation.

Broad and irregular spreading of spotted reagents can increase the dissolving time. A uniform spot can be predictably dissolved in a certain amount of time. Irregular spots have some thicker parts that need a little more time to dissolve. A slight increase in dissolution time per sample can add up to a significant time loss in the screening of a million reagents. Inconsistent redissolution times of irregular spots can reduce the reproducibility of reagent recovery.

No single type of chip surface, such as metal, plastic, or glass, can prevent broad spreading of reagents in all solvents. Broad sample spreading can occur where a particular reagent solvent has too much affinity for the chip surface. For example, organic solvents can wet plastics and spread broadly. Broad spreading can make cross-contamination likely and reagent recovery difficult.

Reagent adsorption can also be a problem with various chip surfaces. Some glass is hydrophilic. Most plastics are lipophilic. Nonspecific adsorption can occur, for example, between a lipid reagent and a plastic chip surface. Where there is a high affinity between a reagent and a chip surface, recovery can be poor, and/or slow. No single surface can provide an ideal low affinity characteristic for all types of reagents.

Reagent array chips can be treated by cleaning or silanization to provide somewhat more consistent properties and higher reagent recoveries. However, cleaning chips can be expensive, can introduce surfactant residues and does not address the irregularities inherent in glass surfaces. Treatment of the chips with silanes can cover over irregularities of the glass surface, but may introduce new inconsistencies associated with amorphous and/or multilayer silane surfaces.

Reagent array chip technologies can benefit from compositions and methods that can provide: reagent spotting without pre-alignment, high density spotting and recovery, uniform drying of spotted reagents, low nonspecific adsorption of reagents, high recovery of reagents, consistent recovery of reagents, and compatibility with diverse solvents and reagents. The present invention provides these and other features that will be apparent upon complete review of the following.

### SUMMARY OF THE INVENTION

Embodiments of the present invention provide high-density array chips with self-assembled monolayer (SAM) surfaces to receive reagents. These SAM surfaces can be optimized for high and consistent recovery of reagents, and compatibility with reagents and solvents. SAM surfaces in accordance with the invention can provide high density arrays without cross-contamination. Reagent array chips in accordance with the invention can provide reagent spotting at high density without pre-alignment while providing high precision dissolution and recovery of reagents.

One aspect of the invention is a reagent array chip with an array of reagents spotted in removable contact with a self-assembled monolayer formed at an interface on the surface of a substrate.

In one embodiment of the invention, the substrate is glass with an interface of gold or silver, and the self-assembled monolayer is formed from molecules having sulfide, thiol, or disulfide binding groups. The SAM molecules can be, for example, alkane thiols, such as 1-undecane thiol, 1-hexadecane thiol, 16 mercapto-1-hexadecanol, and/or 11-mercapto-1-undecanol.

A variety of interface/SAM combinations are provided in the invention. For example, the interface could be glass and the SAM formed from a silane. In other illustrative embodiments, the interface could be a metal oxide with a SAM of fatty acids, or the interface could be a phosphate with a SAM formed from phosphonates.

Reagents in solution can be spotted onto SAMs in accordance with the invention to prepare a reagent array on a chip. Each reagent in the array could be, for example, a protein, a nucleic acid, a cytokine, a receptor, a pharmaceutical, a virus, a buffer, a co-factor, a modulator, an inhibitor, an activator, a chemical, a compound, and/or a mixture thereof. In some embodiments, the reagents in the array can form a reagent library.

In some embodiments, the array chip can be provided with one or more water insoluble alignment marks. Suitable alignment marks include a polymer excipient insoluble in aqueous solvents, and a dye present in an amount sufficient to render the mark substantially opaque. The reagents of the invention can be, e.g., spotted onto the self-assembled monolayer in fixed register with respect to the alignment marks.

The SAM reagent arrays of the invention can provide very high density array spotting and recovery of reagents. Adjacent spotted reagent locations on array chips of the invention can be from 2 mm to about 0.9 mm, to about 0.5 mm, or less, as measured center to center.

Array chips in accordance with the invention can include a patterned region on the substrate surface wherein the self-assembled monolayer is formed and an unpatterned region wherein the self-assembled monolayer is excluded from at least a portion of the unpatterned region. A second self-assembled monolayer can be formed, for example in the unpatterned region, and substantially excluded from the patterned region.

The invention also provides methods of spotting reagents wherein a self-assembled monolayer is formed at an interface on a surface of a substrate, and reagents are spotted onto the self-assembled monolayer. In some embodiments, the self-assembled monolayer can be formed by contacting the interface with a SAM formulation solution and/or by depositing a SAM formulation vapor onto the interface.

Methods of spotting reagents in accordance with the invention include assembling a variety of SAM formulations at a variety of interfaces. In some embodiments, the interface can be glass with a SAM of silane. In other embodiments, the interface can be gold or silver with SAMs assembled from sulfide, thiol (such as an alkane thiol and/or a hydroxy-terminal alkane thiol), and/or disulfide SAM molecule formulations. In still other embodiments, the interface can be a metal oxide with a fatty acid SAM, or the interface can be a phosphate with a phosphonate SAM.

The reagent arrays fabricated using methods of spotting reagents in accordance with the invention can include a protein, a nucleic acid, a cytokine, a receptor, a pharmaceutical, a virus, a buffer, a co-factor, a modulator, an inhibitor, an activator, a chemical, or a compound. Methods in accordance with the invention can provide SAMs with high and/or consistent recovery of desired reagents.

Methods in accordance with the invention of spotting reagents can further include the steps of adding reaction mixture constituents to the reagents, and detecting chemical reactions in the reaction mixture. Reactions and detections can take place on the SAMs of the invention.

Method of spotting reagents to the SAMs in accordance with the invention may include methods to recover the reagents for screening or experimentation. For example, a method in accordance with the invention can include the steps of drying the reagents, dissolving the dried reagents, and collecting (e.g., by a sipper, wetting a solid pin head, and the like) the dissolved reagents from the self-assembled monolayer to recover the reagents from the self-assembled monolayer. In most embodiments reagents can be usefully recovered by application of appropriate solvents, as the reagents are not permanently bound to the self-assembled monolayer. The steps of forming a self-assembled monolayer, spotting, drying, dissolving, collecting, transferring, and/or assessing the dried reagents can be carried out using an automated instrument.

Methods in accordance with the invention of spotting reagents to the SAM chips can include the step of selecting the self-assembled monolayer to provide a desired characteristic in association with a particular reagent composition, wherein the desired characteristic is contact angle, consistent spot size, even distribution of the reagents, roundness of spots, consistent recovery of a reagent, and/or efficient recovery of a reagent. Methods in accordance with the invention can include the steps of selecting the self-assembled monolayer by preparing a series of two or more self-assembling monolayer formulations, contacting the formulations to one or more test interfaces to form monolayers at the test interfaces, applying the reagent composition to the monolayers, measuring a characteristic outcome, and determining which monolayer better provides the desired characteristic outcome. For example, SAM formulations with different hydrophobicity can be combined in various proportions to determine a formulation for optimum spot wetting with a particular reagent solvent. In some embodiments, the SAM formulations comprise molecules with a substrate binding group, an alkane group with a carbon chain ranging in length from about 3 carbons to about 22 carbons, and a terminal group with a hydrophilic or hydrophobic chemical structure. In specific embodiments, the SAM formulations can include alkane thiol and/or a hydroxyl terminal alkane thiol.

Interfaces on array chips substrate surfaces in accordance with the invention can take the form of patterns that can support formation of one or more SAMs in patterned regions. A reagent library array in accordance with the invention can take the form of a chip substrate with a surface comprising a patterned interface and an unpatterned interface, at least one self-assembled monolayer formed in the patterned interface and/or the unpatterned interface, and an array of reagents spotted on the self-assembled monolayer. Patterned SAM arrays in accordance with the invention include reagent libraries spotted to the arrays.

A library array on patterned SAMs in accordance with the invention can be formed on a glass substrate (often quartz glass) and a gold interface (often in a layer applied to a chrome or titanium adhesion layer on the bulk substrate surface). In embodiments where the patterned interface or the unpatterned interface is made up of gold, the SAM can favorably be an alkane thiol. In embodiments where the patterned interface or the unpatterned interface is made up of glass, the SAM can favorably be a silane.

The present invention includes methods of preparing a reagent library on a patterned chip. Embodiments of these methods can be practiced by forming a patterned interface on a surface of a chip substrate, forming one or more self-assembled monolayers on the patterned interface and/or an unpatterned interface of the substrate surface, and spotting one or more reagents to the self-assembled monolayer on the pattern interface and/or on the self-assembled monolayer on the unpatterned interface. Further, in various embodiments the reagents can be dried, dissolved by contacting the dry reagents with a solvent, collected by sipping and/or wetting a pin, and transferred to a separate device for further experimentation. The steps of a method to prepare and recover reagents on a patterned library chip can be, practiced using an automated instrument. Reagents can be spotted onto patterned chips in accordance with the invention at very high densities, such as less than 0.9 mm, or less than 0.5 mm center to center between spots. Reagents in libraries in accordance with the invention can include members composed of proteins, nucleic acids, pharmaceuticals, viruses, buffers, co-factors, modulators, inhibitors, activators, chemicals, and compounds.

In methods in accordance with the invention, the patterned interface or unpatterned interface can be formed by photolithographic or masking methods known in the art. A chromium adhesion layer can be useful to form a substrate surface for application of other metals. A layer of gold can be applied to a chip substrate by sputtering or thermal evaporation, prior to forming the pattern interface. In various embodiments, the patterned/unpatterned interface of a substrate can include surfaces of gold, silver, copper, glass, plastic, silicon, a polymer and/or germanium. Patterned regions can be formed by etching metal layers from a glass bulk substrate using an etchant solution, such as potassium iodide. Patterned interface regions (and generally, an associated unpatterned interface) can be formed by sputtering, depositing, or electroplating a pattern onto a chip surface through a patterned film, mask or a stencil. An unpatterned interface, for purposes of the invention, can be simply an interface associated with residual substrate surface not covered by a patterned interface; an unpatterned interface can be the “negative” print of a patterned interface.

Reagent arrays in accordance with the invention can have patterned and/or unpatterned SAM regions formed by contacting one or more chip interfaces with a SAM formulation optimized to provide high and/or consistent recovery of the reagents from the library. The SAM formulation can be a solution and/or a vapor containing SAM molecules.

In some embodiments reagents can be spotted onto a patterned and/or unpatterned interface. Reagents and/or the reagent solvent can be more or less hydrophobic. SAM formulations can be optimized to provide desired characteristics, such as high recovery, consistent recovery, low cross-contamination, and the like. Reagent hydrophobicity and SAM hydrophobicity in patterned and/or unpatterned regions can be adjusted in any appropriate combination. For example, reagents can be spotted to SAMs on a patterned interface region where the patterned interface is more hydrophobic than the unpatterned interface, or where the patterned interface is less hydrophobic than the unpatterned interface. The reagents can be spotted onto SAMs on an unpatterned interface region where the patterned interface is more hydrophobic than the unpatterned interface, or where the patterned interface is less hydrophobic than the unpatterned interface.

SAMs can be formed on patterned and/or unpatterned interfaces for reagent arrays in accordance with the invention using SAM formulations containing, for example, alkane thiols, hydroxyl alkane thiols, OTS, tri-methyl chlorosilane and HMDS, and the like.

Chip alignment marks can be printed onto array chips of the invention to provide a reference for alignment of equipment that can be used to apply, detect or remove materials located on the chips. The alignment marks can be printed onto a chip substrate using compositions comprising a non-aqueous solvent, a dye soluble in the solvent, and a polymer excipient soluble in the solvent, wherein the composition forms a water insoluble mark when dried on the substrate.

The solvent of the alignment mark composition can be any solvent in which the dye and polymer are adequately soluble. For example, solvents of the composition can be DMSO, DMF, an alcohol, or acetonitrile.

Examples of dyes compatible with embodiments of the invention include acridine, analine, anthraquinone, arylmethane, azo, black nigrosine #7, diazonium, graphite, indulin, imine, nitro, phthalocyanine, quinone, tetrazolium, thiazole, and xanthene. In various embodiments, the dye can be present in an amount ranging from about 1 weight percent to about 20 weight percent of the total composition; from about 3 weight percent to about 15 weight percent of the total composition; or about 10 weight percent of the total composition.

The polymer of the alignment mark composition can be a polyvinyl, a glycan, a glucan, a polyester, a polysaccharide, a polycycloalkylene, a polyether, a polyanhydride, pullulan, and/or the like. In various embodiments, the polymer can be present in an amount ranging from about 0.5 weight percent to about 10 weight percent of the total composition; from about 1 weight percent to about 5 weight percent of the total composition; or about 2 weight percent of the total composition.

The present invention includes an alignment marked substrate comprising a substrate with a surface, and one or more alignment marks made from a substantially water insoluble polymer mixed with a dye present in an amount sufficient to render the alignment mark substantially opaque. The substrate can have, an array of one or more reagents arranged on the substrate surface at locations in a fixed register with respect to the alignment marks.

The marked substrate of the invention can be provided with marks containing one or more dyes, such as acridine, analine, anthraquinone, arylmethane, azo, black nigrosine #7, diazonium, graphite, indulin, imine, nitro, phthalocyanine, quinone, tetrazolium, thiazole, xanthene, and the like. The polymer of the mark can be, e.g., a polyvinyl, a glycan, a glucan, a polyester, a polysaccharide, a polycycloalkylene, a polyether, a polyanhydride, pullulan, and/or the like.

The marked substrate of the invention can have a SAM formed at the substrate surface. The SAM can be formed from, e.g., an alkane thiol and/or a hydroxy-terminal alkane thiol. The SAM can be formed on a patterned and/or an unpatterned interface on the substrate surface.

Embodiments of the present invention also provide methods of applying alignment marks onto reagent array chips. For example, an array of one or more reagents can be spotted onto a surface of the chip, an alignment mark composition can be applied to the surface in fixed register with the reagents, and the reagents and alignment mark composition can be dried to form one or more water insoluble substantially opaque alignment marks on the chip. The alignment mark composition can be applied concurrent with spotting the reagents. In such methods a collector (contact pin set or sipper) can be aligned with reference to one or more alignment marks, one or more dried reagents can be dissolved with a solvent, and the dissolved reagents can be collected from the chip by the collector to recover one or more reagents from the chip. The steps of spotting, applying, drying, aligning, dissolving, collecting, and/or transferring reagents can be effectively carried out using an automated instrument.

In methods in accordance with the invention to apply alignment marks to reagent array chips, the reagent can be a protein, a nucleic acid, a cytokine, a receptor, a pharmaceutical, a virus, a buffer, a co-factor, a modulator, an inhibitor, an activator, a chemical, or a compound.

The alignment mark composition of the method can include, e.g., a solvent, a dye and a polymer. The solvent can be, e.g., a non-aqueous solvent, such as DMSO, DMF, alcohols, acetonitrile and/or the like. The dye can comprise acridine, analine, anthraquinone, arylmethane, azo, black nigrosine #7, diazonium, graphite, indulin, imine, nitro, phthalocyanine, quinone, tetrazolium, thiazole, or xanthene dyes. In various embodiments, the dyes can be present in an amount ranging from about 1 weight percent to about 20 weight percent of the total composition; from about 3 weight percent to about 15 weight percent of the total composition; or at about 10 weight percent of the total composition. The polymer can comprise a polyvinyl, a glycan, a glucan, a polyester, a polysaccharide, a polycycloalkylene, a polyether, a polyanhydride, or a pullulan. In various embodiments, the polymer can be present in an amount ranging from about 0.5 weight percent to about 10 weight percent of the total composition; from about 1 weight percent to about 5 weight percent of the total composition; or at about 2 weight percent of the total composition.

Method in accordance with the invention of applying alignment marks to reagent chips can be practiced on chips having surfaces with SAMs formed at one or more interface. The SAMs can comprise an alkane thiol and/or a hydroxy-terminal alkane thiol. The surfaces can have a patterned region on the chip surface wherein the SAM is formed and an unpatterned region wherein the SAM is excluded from at least a portion of the unpatterned region. The array chip can further have a second SAM selectively formed in the unpatterned region and substantially excluded from the patterned region.

### BRIEF DESCRIPTION OF THE DRAWINGS

FIG. 1 is a schematic diagram cross-section of an array chip having a gold interface and alkane thiol SAM molecules.

FIGS. 2A and 2B are schematic diagrams of high density array chips in accordance with the invention that have alignment marks, and reagent spot separation of 0.9 mm and 0.5 mm.

FIG. 3 is a schematic diagram of a microfluidic device sipping reagents from an array chip.

### DETAILED DESCRIPTION

Embodiments of the present invention provide reagent array chips with self-assembled monolayer (SAM) reagent spotting surfaces for forming high-density arrays that provide consistent spotting and recovering of a diverse variety of reagents. Methods are described for optimizing compatibility of SAM compositions with reagent compositions to provide high density spotting, high recovery, and consistent reagent recovery. Methods of providing alignment marks for collecting reconstituted reagents that do not require pre-alignment at the spotting step are another aspect of the invention.

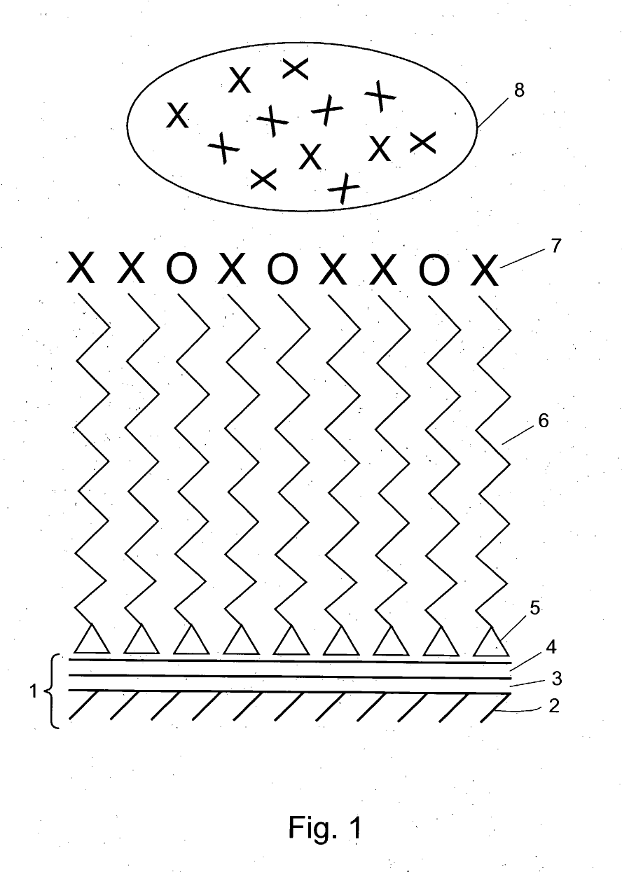

SAM reagent spotting surfaces in accordance with the invention offer consistent recovery of reagents by providing consistent and uniform surfaces to receive the reagents. The SAM molecules can cover a substrate in a tightly packed layer that presents a uniform surface of SAM molecule terminal groups, as shown schematically in FIG. 1. The SAM can cover over irregularities and provide a more consistent surface than materials such as glass, metal oxides, or metals.

A major advantage of employing SAMs instead of other array chip surfaces is the ability to adjust formulations to provide desirable characteristics such as smaller spots, bigger spots, rounder spots, more consistent recovery, and/or higher reagent recovery. This can be accomplished by testing SAM formulations to determine what mixture of SAM molecule types provides the desired outcome with the particular reagents to be stored in an array. SAMs offer a range of reagent spotting surface choices not available with standard array chips.

### Reagent Array Chips

Reagent array chips with self-assembled monolayer (SAM) reagent spotting surfaces comprise a substrate with a surface that provides an interface for self-assembly of molecular monolayers. Reagent libraries can be spotted onto the monolayer in a high-density format. The reagents in the library can be consistently recovered from the monolayer for screening of bioactivity or chemical properties.

Substrates

Substrates for reagent array chips can provide a structural foundation for the chip and a surface for assembly of a monolayer. The structural bulk of the chip substrate provides substance for handling and a solid frame of reference for the array. The surface can be an interface that interacts with SAM molecule binding groups to promote assembly of a monolayer and/or a surface for preparing a patterned interface whereon SAMs can be assembled.

The reagent array chip substrate can be fabricated from materials rugged enough to stand up to handling requirements and solid enough to provide stable surface locations for reagent spotting and collecting. Reagent chips can be stacked in trays while not in use, then manipulated by robots or technicians during screening operations. To provide accurate spotting and collecting of reagents in a high-density format, the substrate should not warp, contract, or break on exposure to process handling, temperatures, and chemicals. Suitable substrate materials include glass (such as quartz, borosilicate, and Pyrex), ceramics, plastic or other polymers, metals, metaloids, and/or combinations thereof.

In embodiments of the invention, the substrate provides a surface interface for assembly of monolayers. The surface interface can be the substrate bulk material and/or a surface layer of interface material uniformly layered or patterned onto the bulk substrate. The interface can be any material suitable to promote assembly of a monolayer with selected SAM molecules. Examples of suitable surface interfaces include glass (such as quartz), ceramics, plastics, gold, silver, metal oxide, or a phosphate. Where the interface material is expensive (e.g., gold or other precious metals), or not rugged, the interface material can be applied as a thin layer to the surface of an appropriate bulk substrate, which could be a less expensive material such as quartz, glass, ceramic, plastic, or non-precious metal.

SAMs

In embodiments of the invention self-assembled monolayers result from affinity interactions and/or covalent bonding of SAM molecules at a surface interface. SAMs assemble in a fashion similar to bilayer structures of soap bubbles or cell membranes, but with a single molecular layer forming at a solid interface. SAMs in embodiments of the invention are molecules with an interface binding group, a linking group and a terminal group. In various embodiments, SAM molecules can include alkane thiols, silanes, fatty acids, or phosphonates.

SAM molecule binding groups associate with and bind to molecules at the substrate surface interface. The binding can be due to an affinity between the binding group and the interface, such as hydrophobic interaction, chelation or ionic interaction. The binding can be a covalent bond, such as a sulfide bond.

In embodiments of the invention, the linking group is a chemical structure that links the binding group to the terminal group. In one embodiment, the linking group is an alkane carbon chain group having from about 3 carbons to about 22 carbons. The alkane chain of one SAM molecule can hydrophobically interact with the alkane chains of adjacent SAM molecules to form a tightly packed association that completely covers the interface.

In embodiments of the invention, the SAM molecule terminal group is oriented away from the interface and provides a new surface that can interact with solvents, buffers and reagents during spotting and screening processes. In various embodiments, the terminal groups can be ionic, chelating, hydrophilic, or lipophilic, to give the exposed surface of the SAM a desired character. Mixtures of SAM molecules, with different terminal groups can be selected to form SAMs with tuned characteristics, as described below in the “Tuning SAMs to Reagents and Solvents” section.

In the embodiment shown in FIG. 1, the SAM molecule is an alkane thiol and the interface is gold. In the example provided in FIG. 1, substrate 1 is made up of glass bulk substrate 2 with a chromium adhesion layer 3 and gold interface 4. Thiol binding group 5 is covalently bound to gold interface 4 through a sulfide bond. Alkane linkage group 6 is eleven carbons long and links binding groups 5 to terminal groups 7. In this embodiment, linkage groups 6 hydrophobically interact (e.g., through Van der Waals interactions) along their length to form a tightly assembled layer that can exclude other molecules. Terminal groups 7 include hydrophobic methyl (—CH₃) groups and hydrophilic hydroxyl (—OH) groups, such as those present in 1-undecane thiol and 11-mercapto-1-undecanol. Reagent solutions 8 can be spotted onto the SAM, as described below in the “Spotting Reagents” section.

Other interface/SAM combinations in accordance with the invention include glass/alkylsilane, silver/thiol, metal oxide/fatty acid, and phosphate/phosphonate. Thiols interact with silver interfaces to form a sulfide bond, as described above with the gold embodiment. Embodiments of the invention involving sulfide bonds can be derived from reaction of SAM molecules having binding groups containing sulfide, thiol, and/or disulfide chemical structures. Carboxyl binding groups of fatty acids can associate, possibly through the formation of ionic bonds, with a metal oxide interface to promote the assembly of a monolayer. Phosphonates can interact with metals chelated at the surface of a solid supported phosphate to form a monolayer. In each case, the binding groups can be combined with linker groups and terminal groups to prepare monolayers with desired solvent and/or reagent interaction characteristics.

Patterned Interfaces

A reagent array chip in accordance with the invention can have one or more type of interfaces in a pattern on the surface of the substrate. The remaining chip substrate around the patterned interface (an “unpatterned” interface) can also provide an interface for assembly of another type of SAM. Multiple patterned and/or unpatterned interfaces on a chip can allow assembly of more than one type of SAM on the same chip for high-density processing and/or SAM compatibility with diverse solvents and reagents on the same chip.

A patterned region of spotting locations surrounded by an unpatterned region of reagent exclusion can provide for very high-density spotting and recovery of reagents. For example, a reagent in an aqueous solvent can be spotted onto a small patterned region of a hydrophilic SAM surrounded by an unpatterned region of hydrophobic SAM. The aqueous reagent will be attracted by the hydrophilic SAM and repelled by the hydrophobic SAM to stay in the small patterned region. This configuration allows a larger amount of reagent to be spotted in the small patterned region without the excessive spreading that would occur if a hydrophobic unpatterned region did not surround it. The larger amount of reagent can dry in a concentrated form within the patterned region. When an aqueous recovery buffer is added to the reagent, the chances of cross-contamination are minimized by the corralling effect of the surrounding hydrophobic region.

In another embodiment, the reagent can be dissolved in an organic solvent that is attracted to hydrophobic SAMs and repelled by hydrophilic SAMs. The reagent can be spotted to a small patterned region of hydrophobic SAMs surrounded with an unpatterned region of hydrophilic SAMs to obtain the benefits of high density spotting and low cross-contamination, as described above.

In still another embodiment, benefits of high density spotting and low cross-contamination can be obtained using a single type of SAM in a patterned region on a reagent array chip. For example, a reagent in an aqueous solvent can be spotted onto a small patterned region of a hydrophilic SAM surrounded by a hydrophobic plastic substrate surface that does not contain SAMs. The aqueous reagent will be attracted by the hydrophilic SAM and repelled by the hydrophobic plastic to stay in the small patterned region. Those skilled in the art will appreciate variations on the theme, such as applying reagents in an organic solvent to a small patterned region of hydrophobic SAMs surrounded by a substrate of hydrophilic glass, or applying aqueous reagents to unpatterned regions of hydrophilic glass substrate surrounded by a patterned region of hydrophobic SAMs, and the like.

Hydrophobic, hydrophilic and/or intermediate SAMs (described in the “Tuning SAMs to Reagents and Solvents” section below) can be assembled on patterned and/or unpatterned regions of the same chip to provide optimum spotting, dissolving, and/or collecting for of a variety of different reagents and/or solvents on the same chip. Some reagent libraries, such as molecular libraries, peptide libraries, chemical collections, and natural extracts collections, can contain both water-soluble and lipid soluble reagents. Many libraries include reagents that nonspecifically adsorb to one SAM or substrate more than others. Those skilled in the art will appreciate, from the disclosure herein, how SAMs and substrates on the same chip can be adjusted to accommodate a variety of solvents and reagents.

Reagent Arrays

Reagent libraries can be spotted onto SAMs of the invention at high density. A large number of reagents can be spotted to a single array chip to make them available to screen for chemical and biological activities of interest.

Reagent arrays on high-density chips are generally prepared as replicates of master libraries in microtiter plate storage. For example, libraries of dissolved molecular reagents can be held in frozen storage using standard 384-well microtiter plates. High-density array chips plates can be prepared by thawing the microtiter plates, dipping pins into the wells, and touching the pins to positions on the chips, thereby transferring reagents to spots on the chip where they are dried.

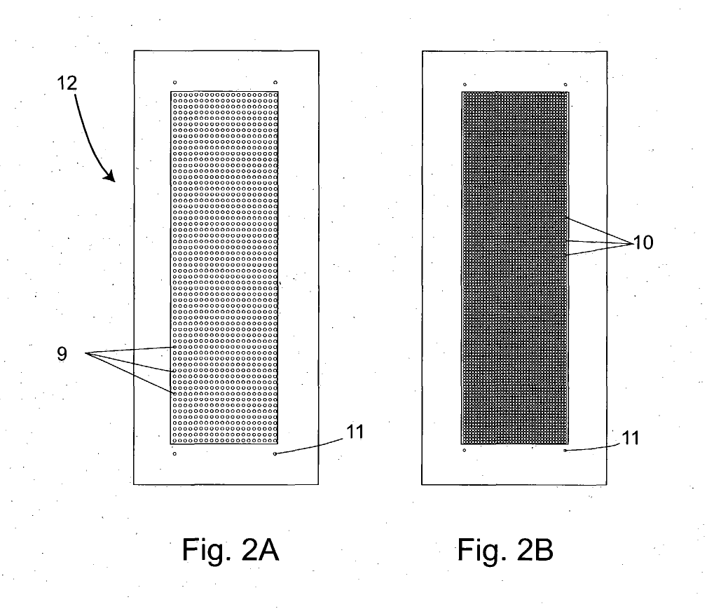

In embodiments of the invention, such as the embodiments shown in FIGS. 2A and 2B, reagents spotted onto reagent array chips 12 can be recovered from spots 9 separated by 0.9 mm, or smaller spots 10 separated by 0.5 mm, or less, as measured center to center. Therefore, an array of reagents with spots spaced at 0.5 mm on a single chip with 36 rows and 120 columns can hold 4320 reagents (representing the contents of about eleven 384-well or forty-five 96-well microtiter plates) in a space of about 11 square centimeters.

Reagents of the invention can include molecules that prospectively have a desired chemical or biological activity. Typical reagent molecules of the invention include proteins, nucleic acids, cytokines, receptors, pharmaceuticals, viruses, a buffer, a-cofactor, a modulator, an inhibitor, a chemical, and/or a compound.

Master libraries of reagents can be prepared by any appropriate methodologies known in the art. Master libraries can be collections of individually synthesized, extracted, or purified molecules. Molecular libraries of chemical compounds, peptides, or nucleic acids can be synthesized on a solid support by a random or systematic series of computer controlled process steps. Libraries of peptides or nucleic acids can be prepared using phage library systems known in the art.

Reagents that may be arrayed in embodiments of the invention are not permanently bound to the SAMs. Instead, reagents arrayed in embodiments of the invention are in removable contact with the SAMs. SAMs of the invention can be optimized to minimize interactions with the reagents, thus providing consistent and/or high recoveries, as described below in the “Tuning SAMs to Reagents and Solvents” section.

Alignment Marks

The alignment marks in embodiments of the invention provide the precision and accuracy required for spotting, dissolution and collecting operations involving the very high-density reagent arrays of the invention. The alignment marks in embodiments of the invention save time by providing for printing marks in register at the same time reagents are spotted, thus eliminating the step of pre-alignment of preprinted marks with the spotting instrument before spotting can begin.

As shown in FIGS. 2A and 2B, reagent array chips 12 in accordance with the invention can be provided with alignment marks 11 that aid in determining the location of reagents spotted onto the chip. Alignment marks 11 can be printed onto array chip 12, in fixed register with reagent spots 9 and 10, onto the self-assembled monolayer of the reagent array chip. The marks 11 can be printed onto the chip during the spotting process. Two or more alignment marks can be printed onto each array chip of the invention to provide more precise registration of the chip in two or three spatial dimensions.

The alignment marks in embodiments of the invention can be printed using a composition that dries to a water insoluble mark. The formulation of the composition can include a dye and polymer excipient soluble in a non-aqueous solvent.

The dye of the alignment mark can be substantially opaque, that is, readily detectable in a dried mark by a technician or automated instrument. The dye can be a acridine, analine, anthraquinone, arylmethane, azo, diazonium, indulin, imine, nitro, phthalocyanine, quinone, tetrazolium, thiazole, and/or xanthene dye. The dye can be present within a composition in an amount that is readily detectable on drying, which could range from about 1 weight percent to about 20 weight percent, from about 3 weight percent to about 15 weight percent, or about 10 weight percent of the composition.

The polymer excipient in the composition provides a substantially water insoluble matrix to adhere the dried composition to the surface of the array chip substrate. The polymer excipient can be a polyvinyl, a glycan, a glucan, a polyester, a polysaccharide, a polycycloalkylene, a polyether, a polyanhydride, and/or the like. The polymer excipient can be present in the composition in an amount adequate to adhere the dye to the chip substrate, which could range from about 0.5 weight percent to about 10 weight percent, from about 1 weight percent to about 5 weight percent, or about 2 weight percent of the composition.

The solvent of the composition can be selected to dissolve the desired dye and the desired polymer excipient. The solvent can evaporate from the composition by about the end of a typical reagent spotting and drying process, or sooner. The solvent of the alignment mark printing composition can be any solvent adapted to dissolve a selected dye and excipient, such as DMSO, DMF, an alcohol, acetonitrile, and the like.

### Methods of Making and Using SAM Reagent Arrays

SAM reagent arrays can be made and used by contacting a SAM molecule formulation to a substrate interface to form a SAM, spotting reagents to the SAM surface, drying the reagents, dissolving the reagents in recovery buffer, collecting the reagents, and transferring the reagents to reaction mixtures to detect chemical or biological activity. The SAM formulation can be optimized to provide desired solvent and/or reagent interactions. The substrate interface can be patterned to provide formation of SAM regions and/or substrate regions, whereby very high-density arrays with a variety of solvents and/or reagents can be processed.

Forming SAMs

In embodiments of the invention, self-assembled monolayers (SAMs) can be formed through the interaction of SAM molecules at a surface interface. SAM molecules in accordance with the invention comprise a binding group, a linking group, and a terminal group. The binding groups have a specific affinity for the interface and the linking groups have an affinity for one another. Self-assembly of the monolayer results when a SAM formulation contacts an appropriate interface where SAM molecules accumulate as binding groups interact with the interface. In some embodiments, the linking groups of the accumulated SAM molecules can hydrophobically interact to arrange the SAM molecules together with the terminal groups oriented away from the interface. As more and more SAM molecules adsorb to the interface, a continuous monolayer of tightly packed molecules can form. The interface can be substantially covered with the monolayer, thus providing a new exposed surface primarily composed of terminal groups.

The process of contacting an interface with a SAM formulation can include immersing the interface in a liquid phase SAM formulation solution. After the SAM is formed, excess formulation can be rinsed away. Optionally, contacting an interface with a SAM formulation can include exposing the interface to a SAM formulation in vapor phase without needing to rinse away excess formulation.

Patterned SAMs

Where an appropriate interface is present as a pattern on a chip, SAMs specific to the interface can be formed in the pattern. Unpatterned surfaces of the substrate can exclude SAMs or provide a different interface specific to binding groups of another of SAM type.

Lithography techniques, such as those known in the art, can be used to form patterned interface regions on the surface to a chip substrate. For example, a chip substrate surface is provided with various layers including a glass bulk substrate, a chromium adhesion layer, a gold layer, and a polymeric resist film layer that is degraded by exposure to light. A pattern is imprinted by exposing the resist layer to UV light through a mask or stencil, or by drawing the pattern with a laser. The chip surface is exposed to a solution of potassium iodide that etches through the gold and chromium layers wherever the resist layer has been removed. After rinsing away the potassium iodide, the remaining resist is removed by heat, or with solvents, to reveal a patterned interface region of gold and an unpatterned interface region of quartz. Similar schemes of photolithography and etching will be appreciated by those skilled in the art for patterning interfaces of silver, copper, germanium metal oxides, phosphates, glass, plastic, silicon, and the like.

As an alternative to etching, metal layer patterns can be deposited onto a substrate by other methods known in the art, such as electroplating, sputtering, and thermal evaporation. Unpatterned regions can be covered with a mask or stencil to prevent deposition of the metal. When the mask or stencil is removed, there remains a patterned region of metal and an unpatterned region of bulk substrate material.

Patterned and/or unpatterned SAM interfaces can be effectively formed on the substrate by a variety of other methods known in the art. For example, interface surfaces capable of interaction with SAM molecules can be deposited by stamping, soft lithography, microcontact printing, and the like.

One or more SAMs can be assembled on patterned interfaces, or unpatterned interfaces, formed as described above. For example, where a gold patterned interface is formed on a glass unpatterned interface, contact with an alkane thiol SAM formulation will specifically provide a SAM on the gold interface. The unpatterned glass interface can be left without a monolayer, or one can be formed using a SAM formulation specific for glass interfaces, such as an alkylsilane formulation.

Tuning SAMs to Reagents and Solvents

SAM formulations in accordance with the invention can contain more than one type of SAM molecule specific for the same type of interface to provide SAMs with desirable reagent and/or solvent interactions. For example, if a SAM from one formulation is hydrophobic so an aqueous reagent beads high on spotting, and a SAM from another formulation is hydrophilic so the aqueous reagent wets to spread broadly on spotting, a certain mixture of SAM molecules from the two formulations can provide a SAM whereon the reagent spots to a desired width.

SAMs can be tuned to provide a desired characteristic outcome by optimizing a measurable parameter correlated with the characteristic. Useful measurable parameters for tuning SAMs include contact angle, consistent spot size, even distribution of the reagents within the spots, consistent recovery of a reagent, efficient recovery of a reagent, and the like. The hydrophobicity of the SAM often has a significant effect on the interaction of the reagent solvent with the SAM, thereby affecting the spot size and recovery consistency. The choice of SAM molecule terminal groups can have a strong influence on the non-specific adsorption of reagent molecules to the SAM, thereby affecting recovery efficiency.

Contact angle, for example, is the angle formed between the air/liquid interface and a horizontal solid surface on which the drop is resting. If the liquid is repelled by the surface, the sides of the drop can be vertical or protrude to an angle of 90 degrees or more. If the liquid is attracted to the surface, the sides of the drop can spread out for a contact angle of 90 degrees or less. Contact angle measurements can correlate to reagent array characteristics, such as the size of the dried reagent spots.

To select a SAM with a desired characteristic, SAMs can be formed on interfaces with two or more SAM formulations. Reagents can be applied to the SAMs and characteristic outcomes (e.g., parameters correlated with desired characteristics) can be measured. The SAM that provides a better characteristic outcome, such as reagent recovery, consistent reagent recovery, consistent spot size, a high degree of roundness, and/or small spot size, is selected. Such simple experimental comparisons can determine optimal combinations of SAM molecules in a formulation to obtain the SAM most compatible with a particular solvent or reagent. Regression analysis can be used to determine an optimal SAM formulation from experiments on a limited number of test formulations.

Spotting Reagents

Spotting reagents onto a SAM reagent array chip can be preformed by any appropriate technique known in the art. For example, reagents can be manually spotted to locations on the SAM surface using a multi-channel pipettor. Automated and robotic methods are known in the art to rapidly and reproducibly spot reagents to an array.

As many reagents dry to a clear or translucent spot, it is useful to have a grid pattern or alignment marks printed on the chip. Where automated equipment is used, it can be convenient to have the alignment mark formulation of the invention printed in register with the reagent array during the spotting process.

The SAMs, tuned SAMs and patterned SAMs of the invention provide high density spotting of arrays without cross-contamination of reagents. Technologies of the invention allow spotting of reagents with spacing of about 0.1 mm or less between adjacent spots, as measured center to center. However, due to the limitations of buffer handling in dissolving and collecting operations, spotting of reagents for recovery from high-density arrays of the invention is generally limited to spacing reagent spots not less than about 0.4 mm between adjacent spotted reagent locations, as measured center to center.

Reaction mixture constituents can be added to reagents spotted on SAM reagent array chips. The constituents can include one or more reaction substrates, catalysts, enzymes, and/or detection molecules. Reaction mixtures can be constituted before the spotted reagent dries, or after drying. Reaction detection can take place with the reaction mixture on the chip, or after the reaction mixture is transferred to detection instrumentation.

Drying

After reagent solutions have been spotted onto the SAM reagent array chips of the invention, the solvents can be evaporated to ensure the chemical stability and positional stability of the reagent spots. In many embodiments of the invention, ambient conditions usually suffice to dry the reagents on the high-density chips because the volumes involved are small and the surface areas relatively high. However, when reagents are dissolved in certain low vapor pressure solvents, or when water of hydration is high in the reagents and/or excipients, drying can be accelerated, or driven to completion by the application of air currents, vacuum, and/or heat.

Reagents dried on the surface of a SAM are not permanently bound to the SAM molecules. In fact, covalent and affinity interactions between the reagent molecules and the SAM molecules are undesirable, as it can adversely affect recovery of the reagent. Logical selection of SAM molecules with appropriate terminal groups, as will be appreciated by those skilled in the chemical arts, can avoid many of these undesirable interactions. Associations between reagent molecules and SAM molecules can be minimized by tuning the SAMs for maximum reagent recovery.

Dissolving Reagents from Array Spots

Reagents in high-density arrays of the invention are dissolved by application of an appropriate recovery buffer to the reagent spots and waiting for the reagent to dissolve. Because the reagent spots are small with a relatively high surface area, dissolution in recovery buffer is often adequate after three seconds, one second, 0.3 seconds, or less.

Reagent recovery can depend on various factors, such as the choice of buffers, buffer contact time, temperature, fluid mechanics, diffusion rates, dissolution kinetics, excipient substances in the spot, and the like. Recovery time can be reduced by choosing a buffer in which the reagent is highly soluble, drying the reagent with an excipient that dissolves quickly in the buffer, raising the temperature, and/or agitating the buffer.

In some cases, recoveries will be low even with optimum dissolution conditions. For example, where the reagent is a lipid and the SAM is very hydrophobic. Recovery may be poor where the reagent has a negative charge and the SAM has a positive charge. Recoveries can be improved in these situations by using recovery buffers that neutralize the interaction between the reagent and SAM. Improved recovery can be obtained by tuning the SAM for high recovery of the reagent, as described above in the Tuning SAMs to Reagents and Solvents section.

The recovery buffer chosen to dissolve reagents from a SAM array can, e.g., be compatible with chemistries of intended bioactivity screening reaction mixtures. The screening reaction can take place at the reagent spot location or the dissolved reagent can be transferred to an analytical instrument for assay.

Recovery of Reagents

Dissolved reagents can be recovered from SAM array chips of the invention by aspiration, surface contact, capillary action, or the like. Manual or automated methods can be employed to remove the reagents from the chips and transfer them to, e.g., screening reaction mixtures.

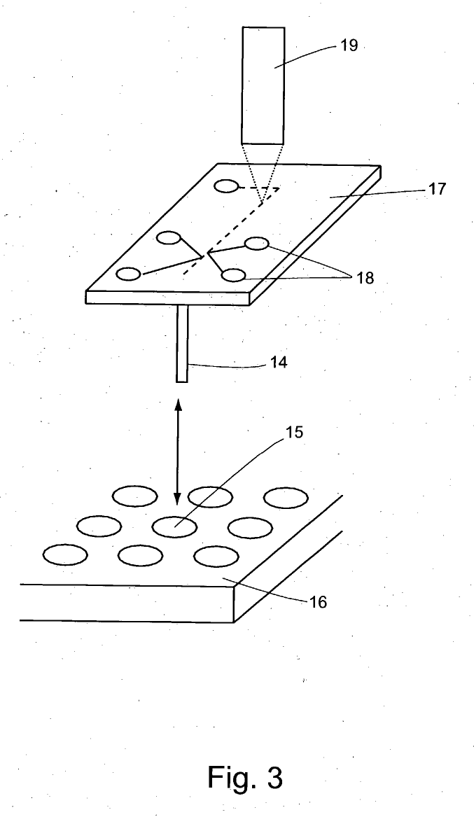

For example, a sipper device that delivers recovery buffer through a hollow tube to dissolve reagent at the SAM array can aspirate the new reagent solution for transfer to a reaction mixture for analysis. The sipper can pause about 0.2 seconds to 3 seconds for the reagent to dissolve before aspiration. The recovered reagent can be transferred to an analytical station by mechanical robotic motions or in a fluid stream in micro-channels connected to the sipper tube. FIG. 3 shows, for example, a schematic diagram of sipper tube 14 recovering reagent 15 from a high-density array chip 16. Recovered reagent 15 flows into microfluidic device 17 for mixture with analytical reagents 18 and detection by detector 19.

Optionally, for example, a solid head pin set can deliver recovery buffer and collect reagents from a reagent array chip. A solid pin can be wet by dipping it into recovery buffer. The volume of reagent retained as a droplet on the pin can be largely controlled by the surface area of the pinhead. The reagent can be dissolved by touching the droplet to the reagent spot and allowing time for dissolution to occur. Mechanical oscillations of the pin can help accelerate the dissolution process. Reagents can be collected by contacting the dissolved reagent on the chip with a wettable pinhead to collect a droplet for transfer to analytical instrumentation.

Recovery of reagents can be improved where the SAM repels the recovery buffer. If the reagent was dried in an excipient soluble in the recovery buffer, the applied buffer will wet the spot. When the spot dissolves, the buffer can bead up on the SAM surface to be substantially removed by the collector device.

Collectors in accordance with the invention include any of a variety of mechanical elements and techniques known in the art to recover dry reagents or liquid reagents from a surface. For example, a collector can comprise one or more capillary tubes (sipper) adapted to draw liquid reagents from a surface into the tube bore by the force of pressure differentials or capillary action. In another example, the collector can comprise one or more solid flat pins that can recover reagent molecules by wetting on contact with reagents in solution. See, for example, U.S. Pat. No. 5,779,868, “Electropipettor and Compensation Means for Electrophoretic Bias”, to Parce et al., and U.S. Pat. No. 5,942,443, “High Throughput Screening Assay Systems in Microscale Fluidic Devices”, to Parce et al., which are hereby incorporated by reference in their entirety herein.

Even where recovery is poor, consistent recovery allows valid comparisons to be made in interpretation of experiments. Automated collectors can minimize variable recoveries by consistently controlling buffer volume, temperature and dissolution time from one recovery to the next. Consistent reagent recovery in the invention is further enhanced by formation of consistent reagent spots on the uniform SAM surfaces of the invention.

It is understood that the examples and embodiments described herein are for illustrative purposes only and that various modifications or changes in light thereof will be suggested to persons skilled in the art and are to be included within the spirit and purview of this application and scope of the appended claims. All publications, patents, and patent applications cited herein are hereby incorporated by reference in their entirety for all purposes.

What is claimed is:

1. A reagent array chip comprising a substrate with a self-assembled monolayer formed at an interface on a surface of the substrate; and an array of reagents in removable contact with the self-assembled monolayer.

2. The array chip of claim 1, wherein the substrate comprises glass and the interface comprises gold.

3. The array chip of claim 1, wherein the interface comprises glass and the self-assembled monolayer comprises a silane.

4. The array chip of claim 1, wherein the interface comprises gold or silver, and the self-assembled monolayer comprises a sulfide, a thiol, or a disulfide.

5. The array chip of claim 1, wherein the self-assembled monolayer comprises an alkane thiol.

6. The array chip of claim 5, wherein the self-assembled monolayer comprises 1-undecane thiol, 1-hexadecane thiol, 16 mercapto-1-hexadecanol, or 11-mercapto-1-undecanol.

7. The array chip of claim 1, wherein the interface comprises a metal oxide and the self-assembled monolayer comprises a fatty acid.

8. The array chip of claim 1, wherein the interface comprises a phosphate and the self-assembled monolayer comprises a phosphonate.

9. The array chip of claim 1, wherein at least one reagent is selected from the group consisting of a protein, a nucleic acid, a cytokine, a receptor, a pharmaceutical, a virus, a buffer, a co-factor, a modulator, an inhibitor, an activator, a chemical, and a compound.

10. A reagent library spotted to the array chip of claim 1.

11. The array chip of claim 1, further comprising one or more alignment marks.

12. The array chip of claim 11, wherein the alignment marks are water insoluble.

13. The array chip of claim 11, wherein the alignment marks comprise a polymer excipient insoluble in aqueous solvents, and a dye present in an amount sufficient to render the mark substantially opaque.

14. The array chip of claim 11, wherein reagents are spotted onto the self-assembled monolayer in fixed register with respect to the alignment marks.

15. The array chip of claim 14, wherein the distance between adjacent spotted reagent locations is not more than about 0.9 mm as measured center to center.

16. The array chip of claim 14, wherein the distance between adjacent spotted reagent locations is not more than about 0.5 mm as measured center to center.

17. The array chip of claim 1, further comprising a patterned region on the substrate surface wherein the self-assembled monolayer is formed, and an unpatterned region wherein the self-assembled monolayer is excluded from at least a portion of the unpatterned region.

18. The array chip of claim 17, further comprising a second self-assembled monolayer formed in the unpatterned region and substantially excluded from the patterned region.

19. A method of spotting reagents, the method comprising:
forming a self-assembled monolayer at an interface on a surface of a substrate; and,
spotting reagents onto the self-assembled monolayer.

20. The method of claim 19, wherein forming a self-assembled monolayer comprises contacting the interface with a solution or depositing a vapor onto the interface.

21. The method of claim 19, wherein the interface comprises glass and the self-assembled monolayer comprises a silane.

22. The method of claim 19, wherein the interface comprises gold or silver, and the self-assembled monolayer comprises a sulfide, a thiol, or a disulfide.

23. The method of claim 22, wherein the self-assembled monolayer comprises an alkane thiol, or a hydroxy-terminal alkane thiol.

24. The method of claim 19, wherein the interface comprises a metal oxide and the self-assembled monolayer comprises a fatty acid.

25. The method of claim 19, wherein the interface comprises a phosphate and the self-assembled monolayer comprises a phosphonate.

26. The method of claim 19, wherein the reagent comprises a protein, a nucleic acid, a cytokine, a receptor, a pharmaceutical, a virus, a buffer, a co-factor, a modulator, an inhibitor, an activator, a chemical, or a compound.

27. The method of claim 19, further comprising:
adding reaction mixture constituents to the reagents: and,
detecting chemical reactions in the reaction mixture.

28. The method of claim 19, further comprising:
drying the reagents;
dissolving the dried reagents; and,
collecting the dissolved reagents from the self-assembled monolayer;
thereby recovering the reagents from the self-assembled monolayer.

29. The method of claim 28, wherein the reagents are not permanently bound to the self-assembled monolayer.

30. The method of claim 28, wherein the steps of forming a self-assembled monolayer, spotting, drying, dissolving, collecting, or transferring are carried out using an automated instrument.

31. The method of claim 28, further comprising:
selecting the self-assembled monolayer to provide a desired characteristic in association with a particular reagent composition;
wherein the desired characteristic is selected from the group consisting of:
contact angle, consistent spot size, even distribution of the reagents, spot roundness, consistent recovery of a reagent, and efficient recovery of a reagent.

32. The method of claim 31, wherein selecting the self-assembled monolayer comprises:
preparing a series of two or more self assembling monolayer formulations;
contacting the formulations to one or more test interfaces, thereby forming monolayers at the test interfaces;
applying the reagent composition to the monolayers;
measuring a characteristic outcome; and,
determining which monolayer better provides the desired characteristic outcome;
thereby selecting the self-assembled monolayer.

33. The method of claim 32, wherein the self assembling monolayer formulations comprise two or more molecules with different hydrophobicity.

34. The method of claim 32, wherein:
the self assembling monolayer formulations comprise molecules with a substrate binding group, an alkane group, and a terminal group;
the alkane group comprising a carbon chain ranging in length from about 3 carbons to about 22 carbons; and,
the terminal group comprising a hydrophilic or hydrophobic chemical structure.

35. The method of claim 32, wherein the self assembling monolayer formulations comprise an alkane thiol or a hydroxyl terminal alkane thiol.

36. A reagent library array comprising:
a chip substrate with a surface comprising a patterned interface and an unpatterned interface; and,
at least one self-assembled monolayer formed in the patterned interface or the unpatterned interface; and,
an array of reagents spotted on the self-assembled monolayer.

37. The library array of claim 36, wherein the one interface comprises glass and the other interface comprises gold.

38. The library array of claim 36, wherein the patterned interface or the unpatterned interface comprises gold, and the self-assembled monolayer comprises an alkane thiol.

39. The library array of claim 36, wherein the patterned interface or the unpatterned interface comprises glass, and the self-assembled monolayer comprises a silane.

40. A reagent library spotted to the library array of claim 36.

41. A method of preparing a reagent library on a chip, the method comprising:
forming a patterned interface on a surface of a chip substrate;
forming a self-assembled monolayer on the patterned interface or an unpatterned interface of the substrate surface; and,
spotting one or more reagents to the self-assembled monolayer on the patterned interface or on the self-assembled monolayer on the unpatterned interface;
thereby providing a reagent library.

42. The method of claim 41, wherein forming a patterned interface comprises photolithography.

43. The method of claim 41, wherein forming a patterned interface comprises etching.

44. The method of claim 43, wherein the etching comprises application of etchant solution to the chip.

45. The method of claim 41, wherein forming a patterned interface comprises sputtering, depositing, or electroplating a pattern onto a chip surface through a patterned film, mask or a stencil.

46. The method of claim 41, wherein the chip substrate comprises a chromium adhesion layer.

47. The method of claim 46, further comprising applying a layer of gold to the chip substrate, by sputtering or thermal evaporation, prior to forming the patterned interface.

48. The method of claim 41, wherein the interface on the surface of a chip substrate comprises a metal selected from the group consisting of gold, silver, copper, and germanium.

49. The method of claim 41, wherein the patterned interface or unpatterned interface comprises glass, plastic, silicon or a polymer.

50. The method of claim 41, wherein forming a self-assembled monolayer comprises contacting one or more chip interfaces with a self assembling monolayer formulation optimized to provide high or consistent recovery of the reagents from the library.

51. The method of claim 50, wherein the self assembling monolayer formulation comprises a solution or a vapor.

52. The method of claim 41, wherein the patterned interface comprises reagent spotting locations.

53. The method of claim 52, wherein the patterned interface is more hydrophobic than the unpatterned interface.

54. The method of claim 52, wherein the patterned interface is less hydrophobic than the unpatterned interface.

55. The method of claim 41, wherein the unpatterned interface comprises reagent spotting locations.

56. The method of claim 55, wherein the patterned interface is more hydrophobic than the unpatterned interface.

57. The method of claim 55, wherein the patterned interface is less hydrophobic than the unpatterned interface.

58. The method of claim 41, wherein the molecules which form a self-assembled monolayer are selected from a group consisting of alkane thiols, and Silanes.

59. The method of claim 58, wherein the alkane thiol comprises a hydroxyl group.

60. The method of claim 41, wherein the distance between adjacent reagents spotted to the self assembling monolayers is not more than about 0.9 mm as measured center to center.

61. The method of claim 41, wherein the distance between adjacent reagents spotted to the self assembling monolayers is not more than about 0.5 mm as measured center to center.

62. The method of claim 41, wherein the reagents are selected from a group consisting of a protein, a nucleic acid, a pharmaceutical, a virus, a buffer, a co-factor, a modulator, an inhibitor, an activator, a chemical, and a compound.

63. The method of claim 41, further comprising:
drying the reagents;
dissolving the reagents by contacting the dry reagents with a solvent; and,
collecting the dissolved reagents;
thereby recovering the reagents from the library.

64. The method of claim 63, wherein the steps of forming a pattern, forming a self-assembled monolayer, spotting, drying, dissolving, collecting, or transferring are carried out using an automated instrument.

65. A composition for application of alignment marks to a substrate, the composition comprising:
a non aqueous solvent;
a dye soluble in the solvent; and,
a polymer excipient soluble in the solvent;
wherein the composition forms a water insoluble mark when dried on the substrate.

66. The composition of claim 65, wherein the solvent is selected from the group consisting of DMSO, DMF, an alcohol, and acetonitrile.

67. The composition of claim 65, wherein the dye is selected from the group consisting of acridine, analine, anthraquinone, arylmethane, azo, diazonium, graphite, indulin, imine, nitro, phthalocyanine, quinone, tetrazolium, thiazole, and xanthene.

68. The composition of claim 67, wherein the dye is present in an amount ranging from about 1 weight percent to about 20 weight percent of the total composition.

69. The composition of claim 68, wherein the dye is present in an amount ranging from about 3 weight percent to about 15 weight percent of the total composition.

70. The composition of claim 69, wherein the dye is present at about 10 weight percent of the total composition.

71. The composition of claim 65, wherein the polymer selected from the group consisting of polyvinyl, glucan, glycan, polyester, polysaccharide, polycycloalkylene, polyether, and polyanhydride.

72. The composition of claim 71, wherein the polymer is present in an amount ranging from about 0.5 weight percent to about 10 weight percent of the total composition.

73. The composition of claim 72, wherein the polymer is present in an amount ranging from about 1 weight percent to about 5 weight percent of the total composition.

74. The composition of claim 73, wherein the polymer is present at about 2 weight percent of the total composition.

75. An alignment marked substrate comprising:
a substrate with a surface; and,
one or more alignment marks comprising a substantially water insoluble polymer excipient, and a dye present in an amount sufficient to render the alignment mark substantially opaque, on the surface of the substrate.

76. The marked substrate of claim 75, further comprising an array of one or more reagents, wherein the array is arranged on the substrate surface at locations in a fixed register with respect to the alignment marks.

77. The marked substrate of claim 75, wherein the dye is selected from the group consisting of acridine, analine, anthraquinone, arylmethane, azo, diazonium, graphite, indulin, imine, nitro, phthalocyanine, quinone, tetrazolium, thiazole, and xanthene.

78. The marked substrate of claim 75, wherein the polymer selected from the group consisting of polyvinyl, glucan, glycan, polyester, polysaccharide, polycycloalkylene, polyether, and polyanhydride.

79. The marked substrate of claim 75, further comprising a self-assembled monolayer formed at an interface on the substrate surface.

80. The marked substrate of claim 79, wherein the self-assembled monolayer comprises an alkane thiol or a hydroxy-terminal alkane thiol.

81. The marked substrate of claim 79, further comprising a patterned interface on the substrate surface wherein the self-assembled monolayer is excluded from at least a portion of the patterned interface.

82. A method of applying alignment marks onto reagent array chips, the method comprising:
spotting an array of one or more reagents onto a surface of the chip;
applying an alignment mark composition onto the surface, wherein the reagents are in a fixed register with the alignment mark position; and,
drying the reagents and alignment mark composition;
wherein the mark composition forms one or more water insoluble substantially opaque alignment marks when dried on the chip.

83. The method of claim 82, wherein the reagent comprises protein, a nucleic acid, a cytokine, a receptor, a pharmaceutical, a virus, a buffer, a co-factor, a modulator, an inhibitor, an activator, a chemical, or a compound.

84. The method of claim 82, wherein the alignment mark composition is applied concurrent with spotting the reagents.

85. The method of claim 82, wherein the alignment mark composition comprises a non aqueous solvent.

86. The method of claim 82, wherein the alignment mark composition comprises a dye.

87. The method of claim 86, wherein the dye is selected from the group consisting of acridine, analine, anthraquinone, arylmethane, azo, diazonium, graphite, indulin, imine, nitro, phthalocyanine, quinone, tetrazolium, thiazole, and xanthene.

88. The method of claim 87, wherein the dye is present in an amount ranging from about 1 weight percent to about 20 weight percent of the total composition.

89. The method of claim 88, wherein the dye is present in an amount ranging from about 3 weight percent to about 15 weight percent of the total composition.

90. The method of claim 89, wherein the dye is present at about 10 weight percent of the total composition.

91. The method of claim 82, wherein the alignment mark composition comprises a polymer excipient.

92. The method of claim 91, wherein the polymer selected from the group consisting of polyvinyl, glucan, glycan, polyester, polysaccharide, polycycloalkylene, polyether, and polyanhydride.

93. The method of claim 92, wherein the polymer is present in an amount ranging from about 0.5 weight percent to about 10 weight percent of the total composition.

94. The method of claim 93, wherein the polymer is present in an amount ranging from about 1 weight percent to about 5 weight percent of the total composition.

95. The method of claim 94, wherein the polymer is present at about 2 weight percent of the total composition.

96. The method of claim 82, further comprising:
aligning a collector with reference to one or more alignment marks;
dissolving one or more dried reagents with a solvent; and,
collecting the dissolved reagents from the chip with the collector;
thereby recovering one or more reagents from the chip.

97. The method of claim 96, wherein the steps of spotting, applying, drying, aligning, dissolving, collecting, or transferring are carried out using an automated instrument.

98. The method of claim 96, wherein the solvent comprises DMSO, DMF, alcohols, or acetonitrile.

99. The method of claim 96, wherein the surface comprises a self-assembled monolayer formed at one or more interfaces.

100. The method of claim 99, wherein the self-assembled monolayer comprises an alkane thiol or a hydroxy-terminal alkane thiol.

101. The method of claim 99, further comprising a patterned region on the chip surface wherein the self-assembled monolayer is formed and an unpatterned region wherein the self-assembled monolayer is excluded from at least a portion of the unpatterned region.

102. The array chip of claim 101, further comprising a second self-assembled monolayer formed in the unpatterned region and substantially excluded from the patterned region.
